(19) United States
(12) Patent Application Publication
(10) Pub. No.: US 2020/0167154 A1
(43) Pub. Date: May 28, 2020

(54) COGNITION-BASED ANALYSIS, INTERPRETATION, REPORTING AND RECOMMENDATIONS FOR CUSTOMIZATIONS OF CLOUD-IMPLEMENTED APPLICATIONS

(71) Applicant: International Business Machines Corporation, Armonk, NY (US)

(72) Inventors: Raghuveer P. Nagar, Kota (IN); Peter E. Stubbs, Georgetown, MA (US)

(21) Appl. No.: 16/199,596

(22) Filed: Nov. 26, 2018

(51) Int. Cl. G06F 8/75; G06F 8/41; G06F 8/10; G06N 20/00

(52) U.S. Cl. CPC G06F 8/75; G06N 20/00; G06F 8/10; G06F 8/427

(57) ABSTRACT

A cognition-based system, method, and computer program product for analyzing, interpreting, reporting and recommending one or more customizations of a cloud-implemented application, by: analyzing source code for the application to identify the customizations therein; interpreting one or more requirements that resulted in the customizations; and generating an impact analysis report on the customizations and the requirements, wherein the impact analysis report recommends which of the customizations to implement for one or more clients. The source code for the application may be revised using the impact analysis report.

### BACKGROUND

The present invention relates generally to a cognition-based system and method to analyze, interpret, report and recommend customizations of cloud-implemented applications.

Software companies typically release newer versions of their applications by incrementally enhancing the applications. Which feature to include in an upcoming newer version is usually decided by a product management team based on studies of the applications, as well as client feedback on previous versions of the applications through software support requests, meetings, or conferences.

However, prospective or new clients often request customizations to the applications. In addition, multiple clients may request similar customizations to the applications. Moreover, any such customizations may adversely impact or “break” the applications' features when the applications are upgraded, and/or subsequent versions of the applications may adversely impact or “break” the customizations to the applications.

What is needed, then, are improved systems and methods for managing customizations of applications. The present invention satisfies this need.

### SUMMARY

The invention provided herein has many embodiments useful, for example, in implementing a cognition-based system, method, and computer program product for analyzing, interpreting, reporting and recommending one or more customizations of a cloud-implemented application, by: analyzing source code for the application to identify the customizations therein; interpreting one or more requirements that resulted in the customizations; and generating an impact analysis report on the customizations and the requirements, wherein the impact analysis report recommends which of the customizations to implement for one or more clients. The source code for the application may be revised using the impact analysis report.

The impact analysis report identifies which of the customizations were implemented for the clients. The impact analysis report also recommends which of the customizations to implement for the clients based on one or more client profiles. In addition, the impact analysis report recommends which of the customizations to implement for the clients in an order of priority.

The customizations may comprise one or more custom fields and one or more data attributes bound to the custom fields. Natural language processing is performed on the source code to determine the requirements that resulted in the customizations. In addition, a machine learning based search may be performed to determine the requirements that resulted in the customizations. Moreover, the requirements that resulted in the customizations may be validated.

Client profiles may be used to determine the requirements that resulted in the customizations. In addition, the client profiles may be matched to recommend which of the customizations to implement for the clients.

### BRIEF DESCRIPTION OF THE DRAWINGS

Referring now to the drawings in which like reference numbers represent corresponding parts throughout:

FIG. 1 is a pictorial representation of an illustrative cloud computing environment used for implementing a cognition-based system and method to analyze, interpret, report and recommend customizations of cloud-implemented applications.

FIG. 2 is a block diagram illustrating how the cognition-based system and method to analyze, interpret, report and recommend customizations of cloud-implemented applications are implemented, according to one embodiment.

FIGS. 3A, 3B, 3C and 3D illustrate a use case for the cognition-based system and method to analyze, interpret, report and recommend customizations of cloud-implemented applications, according to one embodiment.

FIG. 4 illustrates a set of functional abstraction layers provided by the cloud computing environment.

### DETAILED DESCRIPTION

In the following description, reference is made to the accompanying drawings which form a part hereof, and in which is shown by way of illustration one or more specific embodiments in which the invention may be practiced. It is to be understood that other embodiments may be utilized, and structural and functional changes may be made without departing from the scope of the present invention.

Overview

When a sales team of a software company meets with prospective or new clients, or when an implementation team of the software company implements the application for the new clients, the clients often specify requirements and request customizations to the application to meet those requirements. A first problem for the software company is how to respond to these requirements and requests, including what customizations to recommend based on existing clients with similar requirements.

A second problem for the software company is how to identify the features that are commonly customized by similar clients, and why they were customized, in order to consider these customizations as enhancements for an upcoming newer version of the application. However, this information may not be known to the sales or implementation teams, nor reflected in any studies performed by a product management team of the software company, nor reflected in any client feedback on previous versions of the application. Indeed, for existing clients, other features may have been more important for the formal feedback on the previous versions of the application.

A third problem for the software company is how to avoid adversely affecting any customizations made for clients in the previous versions of the application. When a software development team for the software company works on an upcoming newer version of the application, they need to ensure, for every enhancement they make, that the clients upgrading to the newer version of the application are not adversely affected. This requires that the software development team perform an impact analysis for the newer version of the application as compared to the previous versions of the application.

There are no known reliable solutions for these problems mentioned above in the prior art. On the other hand, the present invention solves these problems.

For the first problem, the sales and implementation teams depend on information from the product management team and the implementation team who customized the application. However, there may be different teams that are performing customizations or extensions for various clients, and there likely is not a single person who can possibly know all of the information for all of the clients.

Moreover, collecting this information manually make take some time, especially if the application is implemented globally and/or locally. Additionally, reviewing the software associated with the customizations typically requires advanced technical knowledge.

For the second problem, the product management team depends on the information they have collected through any studies or client feedback. Historically, feedback can be collected only from clients that are willing to give the feedback. Often, many clients are unwilling to provide the feedback. This leaves the product management team with at best only partial information for important decisions.

For the third problem, the software development team may not know how the customizations have been implemented for all of the clients. This lack of clarity often results in extra time spent in the design, development and testing phases. When the software development team does not know what is being used, they have to assume that everything is being used. As such, they may end up spending more time implementing a feature with backwards compatibility in mind when no client even uses the feature.

The present invention solves all three problems, by providing a cognition-based system and method to automatically extract, categorize, and define the types of customizations that have actually been implemented on a cloud-based application. Specifically, the present invention extracts information on any customizations performed on the cloud-based application, and then analyzes and interprets the information using various techniques, including natural language processing and machine-learning techniques, to organize this information in a format that can be understood by sales, product management, software development and implementation teams.

One novel aspect of the present invention is that it provides a system and method for analyzing one or more cloud-implemented applications to identify the customizations performed on the application, implemented in one or more previous versions, and on behalf of which clients. Another novel aspect of the present invention is that it provides a natural language processing and machine-learning-based system and method for analyzing the cloud-implemented applications to identify the customizations performed on the software, interpreting the requirements that resulted in the customizations, and then generating a report in a format that can be understood by the various teams of the software company. In both novel aspects of the present invention, cognitive services may recommend customizations for the application based on client profiles. Moreover, in both novel aspects of the present invention, the cognitive services may recommend customizations as enhancements for newer versions of the application, ordered by priority.

With the application implementation paradigm shifting to software-as-a-service (SaaS), as compared with on-premise implementations, the software company has easier access to the customization details of the SaaS implementations. For SaaS implementations, the proposed analysis, interpretation and report generation can be triggered either periodically (e.g., every weekend, every month, every quarter, etc.), or at an implementation event (e.g., when an implementation is deployed in a production environment). This will ensure that the information provided by the present invention is ready-to-use by the various consumers, such as the sales, product management, software development, and implementation teams.

For the first problem mentioned above, categorizing and defining the types of customizations can be performed based on the requirements of the clients. For example, a marketplace client buying a call center order management application would probably like to know that all other marketplace clients customized an out-of-the-box (OOTB) Order Search screen to add vendor search criterion.

For the second and third problems mentioned above, categorizing and defining the types of customizations can be performed based on a technical, functional and architectural roadmap for the software company and the application. For example, a software company offering a call center order management application will be interested to know how the Order Search screen has been customized in various implementations (whether all or most of the clients add a certain search criterion), but it may not matter to a software company offering only an order administration application.

Cloud Computing Environment

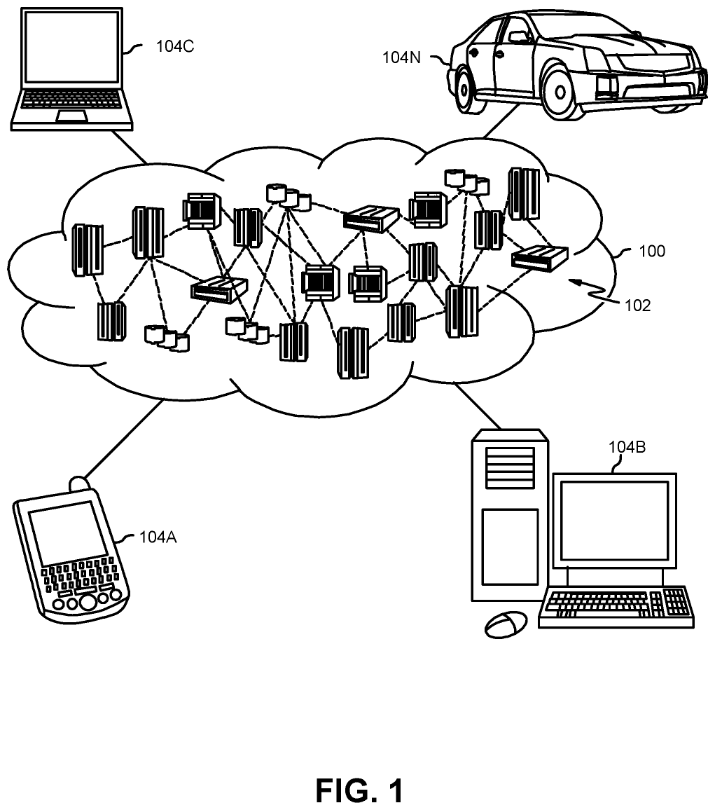

FIG. 1 is a pictorial representation of an illustrative cloud computing environment 100 used for implementing a cognition-based system and method to analyze, interpret, report and recommend customizations of cloud-implemented applications, according to one embodiment.

As shown, a cloud computing environment 100 includes one or more cloud computing nodes 102 with which local computing devices used by cloud consumers, such as, for example, personal digital assistant (PDA) or cellular telephone 104A, desktop computer 104B, laptop computer 104C, and/or automobile computer system 104N may communicate. Nodes 102 may communicate with one another. They may be grouped (not shown) physically or virtually, in one or more networks, such as Private, Community, Public, or Hybrid clouds, or a combination thereof. This allows cloud computing environment 100 to offer infrastructure, platforms and/or software as services for which a cloud consumer does not need to maintain resources on a local computing device. It is understood that the types of computing devices 104A-N shown in FIG. 1 are intended to be illustrative only and that computing nodes 102 and cloud computing environment 100 can communicate with any type of computerized device over any type of network and/or network addressable connection (e.g., using a web browser).

The computing nodes 102 and/or computing devices 104A-N perform various functions and steps as described in more detail below.

System Description

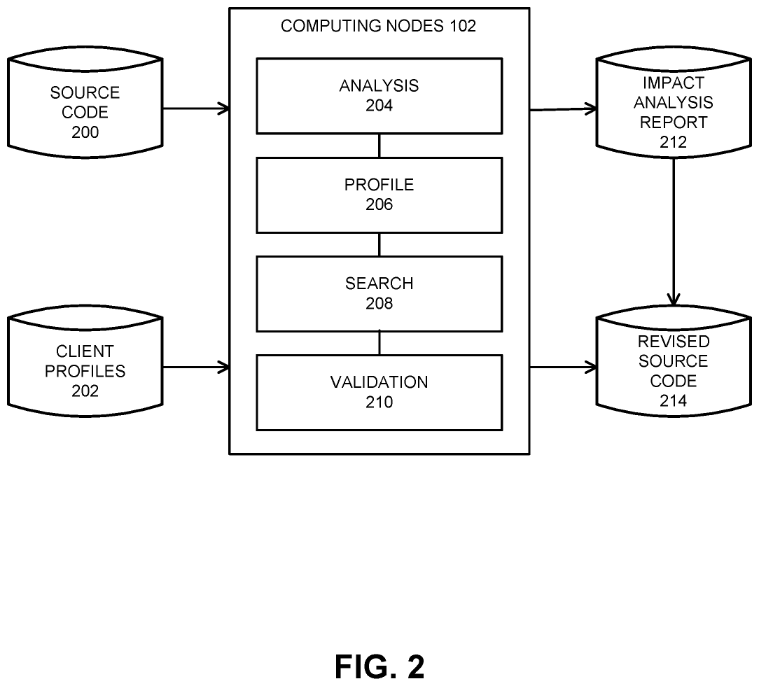

FIG. 2 is a block diagram illustrating how the cognition-based system and method to analyze, interpret, report and recommend customizations of a cloud-implemented application are implemented, according to one embodiment. In this embodiment, the system and method are implemented as follows:
source code 200 for the cloud-implemented application and client profiles 202 are accessed by the computing nodes 102;
a plurality of modules 204-210 executed on the computing nodes 102 analyze and interpret the source code 200 and client profiles 202 in order to report and recommend customizations to the cloud-implemented application; and
an impact analysis report 212 for the cloud-implemented application is generated and used to create revised source code 214 for the cloud-based application.

An Analysis step or function 204 analyzes source code for the application to identify the customizations previously performed therein. This is similar to the analysis performed while generating upgrade reports (which every software company does when releasing a newer version of its application). For example, the Analysis step or function 204 can examine base, extended and/or customized source code 200 components and detect customizations, such as, but not limited to, the following:
Whether a custom field has been added to a screen.
What type of custom field has been added (e.g., a text field, a dropdown, or something else)?
What database attribute is bound to the custom field?
What is the business interpretation of the database attribute and the custom field, i.e., what were the client's requirements that resulted in the customization?

For each customization performed for a client, the Analysis step or function 204 attempts to interpret the requirements that resulted in the customizations. In simple cases, the business interpretation may be available within the application's source code 200. For example, the business interpretation may be available as a description or comment in the definition of the custom field or the database attribute in the source code 200.

However, this information is not always available. When the business interpretation is not available or not found with the application's source code 200, the Analysis step or function 204 invokes cognitive services, such as the Watson™ Natural Language Understanding service offered by International Business Machines Corporation, the assignee of the present invention, although other services could also be used. The Watson™ Natural Language Understanding service performed natural language processing on the source code 200 to extract entities, relationships, keywords, semantic roles, and the like from the source code 200 in order to determine the client's requirements that resulted in the customization.

A Profile step or function 206 uses the client profiles 202 to determine the requirements that resulted in the customizations, for example, when it is not already available or documented in the source code 200. For example, the Profile step or function 206 analyzes customizations performed by or for other clients, and matches the client profiles 202, to interpret the requirements for the customization. If there is similar terminology used with the customizations for other clients, then the customizations were likely performed for similar requirements. The client profiles 202 are also matched to recommend which of the customizations to implement for new or prospective clients.

A Search step or function 208 performs a machine learning based Internet search using search strings formed from the source code 200 to determine the requirements that resulted in the customizations. For example, the customizations may comprise one or more custom fields and one or more data attributes bound to the custom fields, wherein a label of the custom field, a name of the database attribute bound to the custom field, and/or a context for the custom field and database attribute, provide the search strings for the machine learning based search.

Optionally, a Validation step or function 210 can further approve the requirements that resulted in the customizations. Specifically, a user has the ability to confirm the results of the Analysis, Profile and/or Search steps or functions 204, 206, 208 as being accurate, so that future invocations of the Analysis, Profile and/or Search steps or functions 204, 206, 208 can rely on this machine learning. More importantly, the approved requirements can provide machine learning for the cognitive services, so that when the Analysis, Profile and/or Search steps or functions 204, 206, 208 encounter similar customizations, the cognitive services can apply this machine learning to identify the requirements that resulted in this customization.

These steps 204-210 may be repeated as necessary, and any one or more of the steps 204-210 may be omitted as required.

These steps or functions 204-210 generate an impact analysis report 212 on the customizations and the requirements, wherein the impact analysis report 212 recommends which of the customizations to implement for one or more clients. Specifically, the report 212 identifies which of the customizations were implemented in the source code 200, and for which clients, including the requirements that resulted in these customizations.

Further, the report 212 identifies attributes of the client profiles 202, such as domain, i.e., vertical market; business model, i.e., whether it is a multi-channel business; etc. As a result, the present invention can match attributes of the client profiles 202, and recommend which of the customizations to implement for the clients based on the client profiles 202. This solves the first problem.

In addition, the impact analysis report 212 recommends which of the customizations to implement as enhancements in the upcoming newer versions of the application for the clients in an order of priority. This solves the second problem mentioned above.

Moreover, the impact analysis report 212 also provides the details on how the customizations have been performed by the clients. This solves the third problem mentioned above.

With regards to the recommendations, for a feature to be considered as “commonly customized”, and thus of high priority, it is not necessary that the feature has been customized by all of the clients. Instead, a feature can be considered “commonly customized” even if it has been customized by a specified number or percentage of the clients.

A recommendation category that determines priority can be based on the number or percentage of clients and attributes that are matched. For example, if all or most (e.g., 80% or more) of the attributes of a first client match with one or more other clients, then the customizations performed for the one or more other clients will be identified as “must-have” recommendations for the first client. In another example, if some percentage (e.g., 40% to 80%) of the attributes of a first client match with one or more other clients, then the customizations performed for the one or more other clients will be identified as “nice-to-have” recommendations for the first client. In yet another example, if all or most (e.g., 80% or more) of the attributes of a first client match with more than one other clients, and there are both common and mutually exclusive customizations among the other clients, then the common customizations performed for the other clients will be identified as “must-have” recommendations for the first client, whereas the mutually-exclusive customizations performed for the other clients will be identified as “nice-to-have” recommendations for the first client.

The impact analysis report 212 is then used to plan and/or revise the upcoming newer version of the source code 214 and any associated files to ensure its success. As a result, the report 212 provides a new level of insight that has never before been possible.

Use Case

Consider the following use case, wherein a software company develops a call center order management application that is used by clients to capture, query and modify orders, including returns and exchanges.

The call center order management application has been sold to clients belonging to multiple different domains, such as Retail, Telecom, Manufacturing, etc. Moreover, within a domain, there is a variation among the clients based on their business model. For example, among Retail clients, some clients may be multi-channel retailers, some clients may be marketplaces, some clients may sell services, and some clients may have stores.

The present invention analyzes the various customizations made to the source code 200 of the call center order management application for the various clients, as well as the client profiles 202, to generate the impact analysis report 212.

The following table provides one example of how the client profiles 202 are shown in the impact analysis report 212:

| | | | Multi- | Market- | Sells | Has |
|---|---|---|---|---|---|---|
| Client | Type | Domain | channel? | place? | Services? | Stores? |
| Client 1 | Existing | Retail | Yes | Yes | Yes | Yes |
| Client 2 | Existing | Manufacturing | No | No | No | No |
| Client 3 | Existing | Retail | Yes | Yes | Yes | Yes |
| Client 4 | Existing | Telecom | Yes | No | Yes | Yes |
| Client 5 | Existing | Retail | Yes | No | Yes | Yes |
| Client 6 | Prospective | Retail | Yes | Yes | Yes | Yes |

The impact analysis report 212 also includes information identifying the customizations made to the source code 200 of the call center order management application for the various clients, including the requirements (business interpretations) that resulted in those customizations, as shown in the following table:

| # | Screen | Customization | Requirements | Client 1 | Client 2 | Client 3 | Client 4 | Client 5 |
|---|---|---|---|---|---|---|---|---|
| 1 | Order | Added a text | Allow | Yes | Yes | Yes | Yes | Yes |
| | Search | field in the | searching | | | | | |
| | | search criteria | orders based | | | | | |
| | | panel | on vendors | | | | | |
| 2 | Product | Added a new | For the | No | Yes | No | Yes | Yes |
| | Details | tab | product, | | | | | |
| | | | display | | | | | |
| | | | inventory | | | | | |
| | | | details | | | | | |
| 3 | Order | Added a text | Allow | Yes | No | Yes | No | No |
| | Search | field in the | searching | | | | | |
| | | search criteria | orders based | | | | | |
| | | panel | on holds | | | | | |
| 4 | Order | Added a text | Allow | No | No | No | Yes | Yes |
| | Search | field in the | searching | | | | | |
| | | search criteria | orders based | | | | | |
| | | panel | on gift card | | | | | |
| | | | number | | | | | |
| 5 | Order | Hid OOTB | For each of the | No | Yes | No | Yes | No |
| | Search | Postal Code | searched | | | | | |
| | | column in the | orders, do not | | | | | |
| | | search results | display postal | | | | | |
| | | panel | code | | | | | |
| 6 | Order | Added a | For each order | Yes | No | Yes | No | No |
| | Summary | column in the | line, display | | | | | |
| | | grid displaying | vendor | | | | | |
| | | order lines | | | | | | |
| 7 | Order | Added a | For each order | Yes | No | Yes | No | No |
| | Summary | column in the | line, display | | | | | |
| | | grid displaying | carrier | | | | | |
| | | order lines | | | | | | |
| 8 | Order | Hid the | Do not allow | No | No | Yes | No | No |
| | Search | customer zip | searching | | | | | |
| | | code search | orders based | | | | | |
| | | criterion field | on customer | | | | | |
| | | in the search | zip code | | | | | |
| | | criteria panel | | | | | | |
| 9 | Product | Added a data | For each | No | Yes | No | No | No |
| | Search | label in the | searched | | | | | |
| | | repeating | product, | | | | | |
| | | product view | display earliest | | | | | |
| | | panel | shipping date | | | | | |

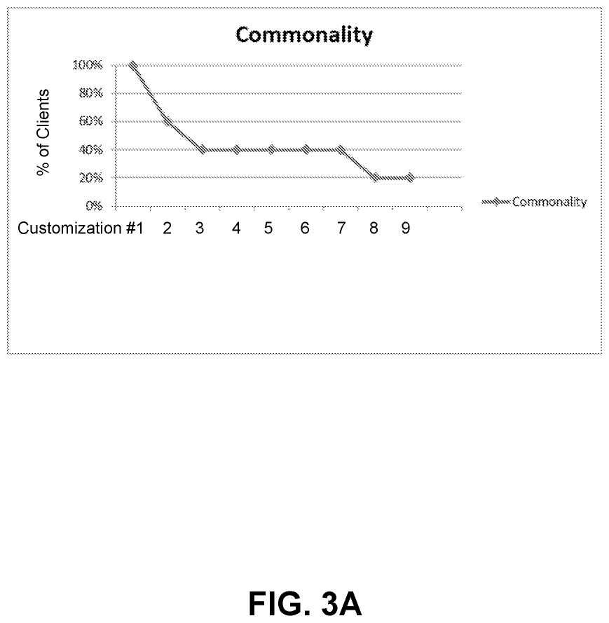

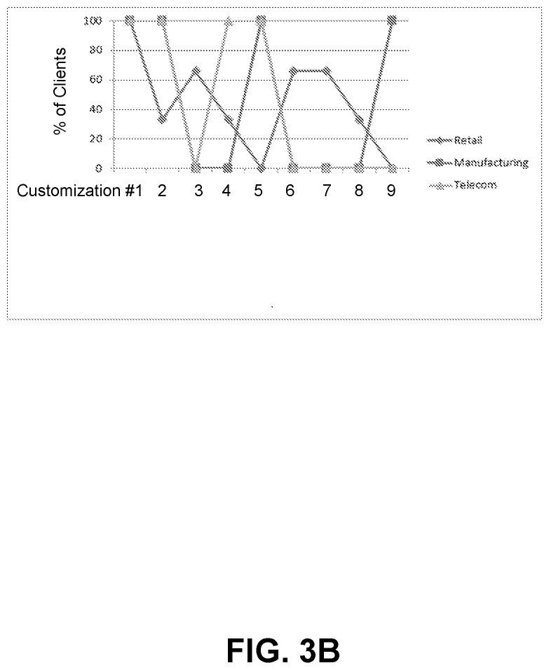

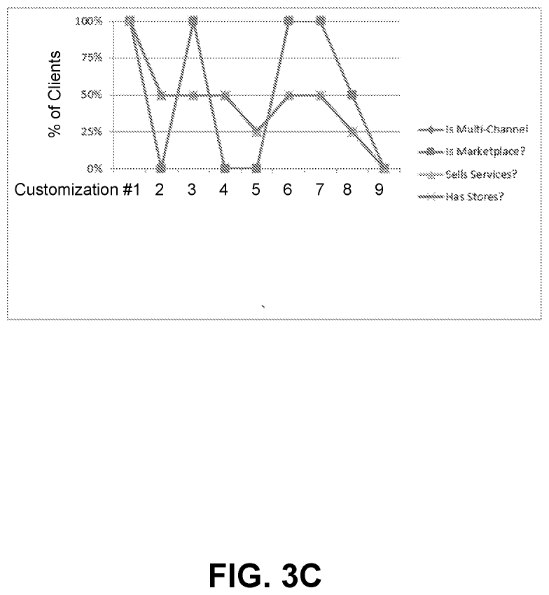

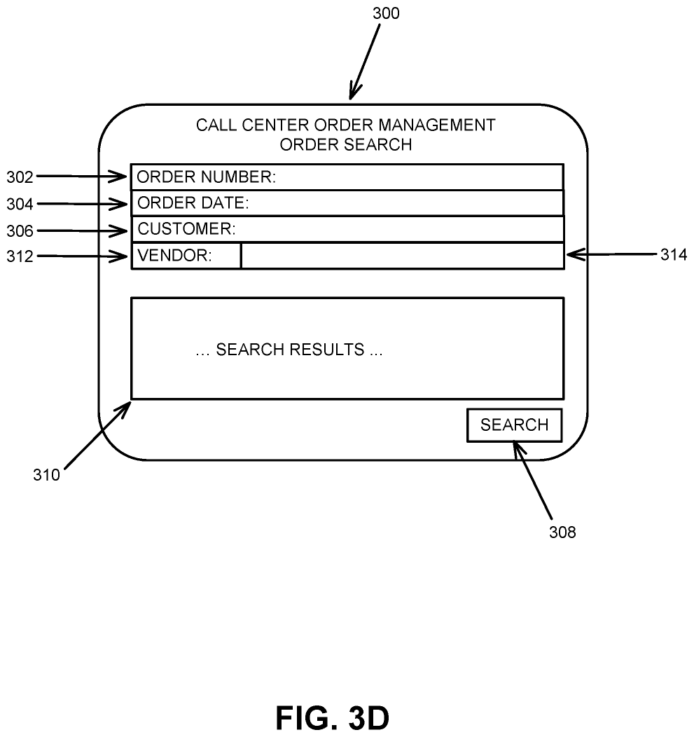

The impact analysis report 212 also generates graphical insights, such as those shown in FIGS. 3A, 3B and 3C, comparing the various customizations. For example, FIG. 3A is a commonality graph showing the percentage commonality vs. the Customization # of the above table; FIG. 3B is a commonality graph showing the percentage commonality vs. the Customization # of the above table based on the Domain of the client (i.e., Retail, Manufacturing, and Telecom); and FIG. 3C is a commonality graph showing the percentage commonality vs. the Customization # of the above table based on the Business Model of the client (i.e., multi-channel, marketplace, sells services and has stores).

Using the impact analysis report 212, it can be seen that the profile of prospective Client 6 exactly matches the profiles of existing Clients 1 and 3. Moreover, the impact analysis report 212 shows that Customization #1 is implemented by all of the existing Clients 1-5.

Thus, when selling or implementing the call center order management application for prospective Client 6, the software company can present Customization #1 as “commonly customized.” However, it is not necessary that one or more features have been customized by all of the clients; instead, a feature can be considered “commonly customized” even if it has been customized by a specified number or percentage of the clients.

FIG. 3D illustrates the implementation of Customization #1 resulting from the impact analysis report 212. The base (non-customized or out-of-the-box) call center order management application has screens for many tasks, such as searching orders, as shown in FIG. 3D, which is an Order Search screen 300. As originally presented, the Order Search screen 300 includes an Order Number field 302, an Order Date field 304, a Customer field 306, a Search button 308 and a Search Results field 310. Customization #1 adds a custom Vendor field 312 that allows for searching orders based on a bound database attribute 314 of vendors, wherein both the custom field 312 and the bound database attribute 314 are added to the revised source code 214.

The software company also can present Customizations #3, 6 and 7 as “must-have” recommendations for prospective Client 6, because these customizations have been performed for both existing Clients 1 and 3, which match the profile of prospective Client 6. However, it is not necessary that all of the attributes of prospective Client 6 match existing Clients 1 and 3; instead, if all or most (e.g., 80% or more) of the attributes match, then the customizations may be identified as “must-have” recommendations.

In addition, the software company can present Customization #8 as a “nice-to-have” recommendation, because it has been performed for Client 3, which matches the profile of prospective Client 6. However, it is not necessary that all of the attributes of prospective Client 6 match existing Client 3; instead, if some percentage (e.g., 40% to 80%) of the attributes match, then the customization may be identified as a “nice-to-have” recommendation.

Like Customization #1, the impact analysis report 212 may be used to plan and/or revise the upcoming newer version of the source code 214 and any associated files to include Customizations #3, 6 and 7 as enhancements because these customizations have been derived as “must-have” enhancements.

Finally, the software company likely would not present Customizations #2, 4 and 5 to prospective Client 6. As can be seen from the above tables, Customization #2 was implemented for Clients 2, 4 and 5; Customization #4 was implemented for Clients 4 and 5; and Customization #5 was implemented for Clients 2 and 5; wherein Clients 2 and 4 are in different Domains from Client 6 and Client 5 has a different business model than Client 6.

Statutory Subject Matter

It can be seen that the present invention provides a number of benefits and advantages:
Provides cognitive insights into how a prospective, new or existing client may customize a cloud-based application.
Based on the recommendations generated by the present invention, clients likely will save substantial time and cost on the implementation of the customizations, avoiding much of the time and expense that otherwise would have been spent in analyzing and deciding which customizations should be implemented.
For the sales, product management, software development and implementation teams of the software company, the present invention provides ready-to-consume insights into the details of the customizations.
These insights may be used by the product management team to further prioritize the customizations as application enhancements, which are prioritized based on the number of implementations, along with the requirements coming from other sources, such as software support system, conferences, etc., for the upcoming newer versions.
The insights may be used by the sales and implementation teams to influence sales of the software and sales of the software-as-a-service (SaaS). For example, these teams may use the common and/or recommended customizations when making presentations to prospective clients.
The insights may be used by the product management team to identify the impact of other requirements (which came from other sources) on the existing implementations.
The insights may be used by the development team to perform an accurate impact analysis when enhancing a feature that is already in use by a client.
The present invention can also be used for on-premise implementations, for example, shared with clients, wherein the output is shared with the software company.

These benefits and advantages include improvements to the technology or technical field of cloud-implemented applications, and more specifically, for a cognition-based system and method to analyze, interpret, report and recommend customizations of cloud-implemented applications.

These benefits and advantages also include improvements to the functioning of the devices themselves, including the cloud computing environment 100 generally and the computing nodes 102 specifically, as compared to prior computer-implemented methods and systems for cloud-implemented applications.

Both generally and specifically, these steps and functions of the computer-implemented method and system comprise specific improvements other than what is well-understood, routine and conventional in the field. Moreover, these steps and functions of the computer-implemented method and system add unconventional steps to a particular useful application.

Cloud Computing

It is to be understood that this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring again to FIG. 1, illustrative cloud computing environment 100 is depicted. As shown, cloud computing environment 100 includes one or more cloud computing nodes 102 with which local computing devices used by cloud consumers, such as, for example, personal digital assistant (PDA) or cellular telephone 104A, desktop computer 104B, laptop computer 104C, and/or automobile computer system 104N may communicate. Nodes 102 may communicate with one another. They may be grouped (not shown) physically or virtually, in one or more networks, such as Private, Community, Public, or Hybrid clouds as described hereinabove, or a combination thereof. This allows cloud computing environment 100 to offer infrastructure, platforms and/or software as services for which a cloud consumer does not need to maintain resources on a local computing device. It is understood that the types of computing devices 104A-N shown in FIG. 1 are intended to be illustrative only and that computing nodes 102 and cloud computing environment 100 can communicate with any type of computerized device over any type of network and/or network addressable connection (e.g., using a web browser).

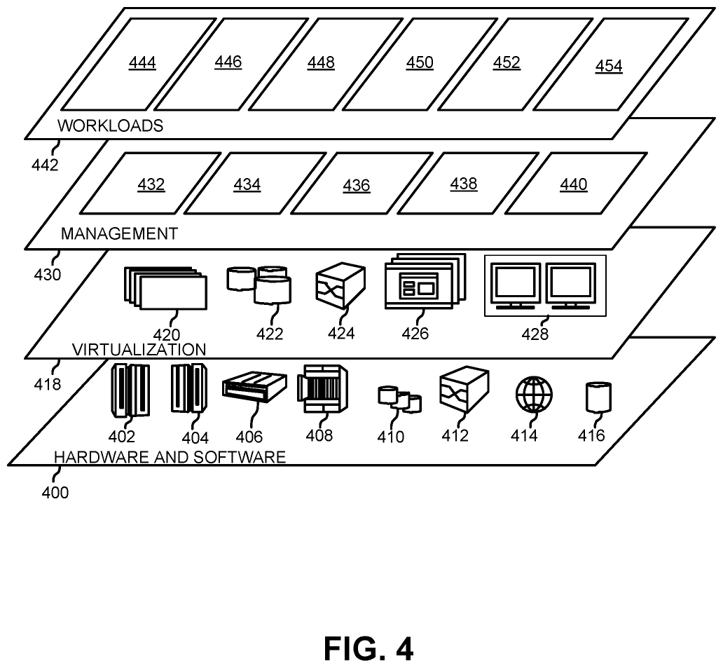

Referring now to FIG. 4, a set of functional abstraction layers provided by cloud computing environment 100 (FIG. 1) is shown. It should be understood in advance that the components, layers, and functions shown in FIG. 4 are intended to be illustrative only and embodiments of the invention are not limited thereto. As depicted, the following layers and corresponding functions are provided:

Hardware and software layer 400 includes hardware and software components. Examples of hardware components include: one or more computers such as mainframes 402, RISC (Reduced Instruction Set Computer) architecture based servers 404, servers 406, and blade servers 408; storage devices 410; and networks and networking components 412. In some embodiments, software components include network application server software 414 and database software 416.

Virtualization layer 418 provides an abstraction layer from which the following examples of virtual entities may be provided: virtual servers 420; virtual storage 422; virtual networks 424, including virtual private networks; virtual applications and operating systems 426; and virtual clients 428.

In one example, management layer 430 may provide the functions described above. Resource provisioning 432 provides dynamic procurement of computing resources and other resources that are utilized to perform tasks within the cloud computing environment 100. Metering and pricing 434 provide cost tracking as resources are utilized within the cloud computing environment 100, and billing or invoicing for consumption of these resources. In one example, these resources may include application software licenses. Security provides identity verification for cloud consumers and tasks, as well as protection for data and other resources. User portal 436 provides access to the cloud computing environment 100 for consumers and system administrators. Service level management 438, which includes containers, provides cloud computing resource allocation and management such that required service levels are met. Service Level Agreement (SLA) planning and fulfillment 440 provide pre-arrangement for, and procurement of, cloud computing resources for which a future requirement is anticipated in accordance with an SLA.

Workloads layer 442 provides examples of functionality for which the cloud computing environment 100 may be utilized. Examples of workloads, tasks and functions which may be provided from this layer include: mapping and navigation 444; software development and lifecycle management 446; virtual classroom education delivery 448; data analytics processing 450; transaction processing 452; etc. More specifically, this layer includes the workloads, tasks and functions 454 for a cognition-based system and method to analyze, interpret, report and recommend customizations of cloud-implemented applications, as described above.

Computer Program Product

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart illustrations and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart illustrations and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart illustrations and/or block diagram block or blocks.

The flowchart illustrations and block diagrams in the Figures illustrate the architecture, functionality, and operation of possible implementations of systems, methods, and computer program products according to various embodiments of the present invention. In this regard, each block in the flowchart illustrations or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

### CONCLUSION

This concludes the description of the various embodiments of the present invention. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Since many embodiments of the invention can be made without departing from the spirit and scope of the invention, the invention resides in the claims hereinafter appended.

1. A computer-implemented method, comprising:
analyzing, interpreting, reporting and recommending one or more customizations of a cloud-implemented application, by:
analyzing source code for the application to identify the customizations therein;
interpreting one or more requirements that resulted in the customizations; and
generating an impact analysis report on the customizations and the requirements, wherein the impact analysis report recommends which of the customizations to implement for clients, wherein the impact analysis report recommends which of the customizations to implement for the clients based on other client customizations, wherein the other client customizations are recommended when a number of attributes from client profiles of the clients that match other client attributes from other client profiles exceeds a threshold.

2. The method of claim 1, further comprising revising the source code for the application using the impact analysis report.

3. The method of claim 1, wherein the impact analysis report identifies which of the customizations were implemented for the clients.

4. (canceled)

5. The method of claim 1, wherein the impact analysis report recommends which of the customizations to implement for the clients in an order of priority.

6. The method of claim 1, wherein the customizations comprise one or more custom fields and one or more data attributes bound to the custom fields.

7. The method of claim 1, wherein natural language processing is performed on the source code to determine the requirements that resulted in the customizations.

8. The method of claim 1, wherein a machine learning based search is performed to determine the requirements that resulted in the customizations.

9. The method of claim 1, further comprising validating the requirements that resulted in the customizations.

10. The method of claim 1, wherein client profiles are used to determine the requirements that resulted in the customizations.

11. The method of claim 1, wherein client profiles are matched to recommend which of the customizations to implement for the clients.

12. A computer-implemented system, comprising:
one or more computers programmed for analyzing, interpreting, reporting and recommending one or more customizations of a cloud-implemented application, by:
analyzing source code for the application to identify the customizations therein;
interpreting one or more requirements that resulted in the customizations; and
generating an impact analysis report on the customizations and the requirements, wherein the impact analysis report recommends which of the customizations to implement for clients, wherein the impact analysis report recommends which of the customizations to implement for the clients based on other client customizations, wherein the other client customizations are recommended when a number of attributes from client profiles of the clients that match other client attributes from other client profiles exceeds a threshold.

13. The system of claim 12, further comprising revising the source code for the application using the impact analysis report.

14. The system of claim 12, wherein the impact analysis report recommends which of the customizations to implement for the clients in an order of priority.

15. The system of claim 12, wherein natural language processing is performed on the source code to determine the requirements that resulted in the customizations.

16. The system of claim 12, wherein a machine learning based search is performed to determine the requirements that resulted in the customizations.

17. The system of claim 12, further comprising validating the requirements that resulted in the customizations.

18. The system of claim 12, wherein client profiles are used to determine the requirements that resulted in the customizations.

19. The system of claim 12, wherein client profiles are matched to recommend which of the customizations to implement for the clients.

20. A computer program product, the computer program product comprising a computer readable storage medium having program instructions embodied therewith, the program instructions executable by one or more computers to cause the computers to perform a method, comprising:
analyzing, interpreting, reporting and recommending one or more customizations of a cloud-implemented application, by:
analyzing source code for the application to identify the customizations therein;
interpreting one or more requirements that resulted in the customizations; and
generating an impact analysis report on the customizations and the requirements, wherein the impact analysis report recommends which of the customizations to implement for clients, wherein the impact analysis report recommends which of the customizations to implement for the clients based on other client customizations, wherein the other client customizations are recommended when a number of attributes from client profiles of the clients that match other client attributes from other client profiles exceeds a threshold.
